(19) United States
(12) Patent Application Publication
(10) Pub. No.: US 2014/0150109 A1
(43) Pub. Date: May 29, 2014

(54) METHOD FOR PROTECTING USER PRIVACY IN SOCIAL NETWORKS

(71) Applicant: B. G. NEGEV TECHNOLOGIES AND APPLICATI, Beer Sheva (IL)

(72) Inventors: Michael FIRE, Nethanya (IL); Yuval ELOVICI, Moshav Arugot (IL); Aviad ELISHAR, Beer Shava (IL); Dimitry KAGAN, Beer Shava (IL)

(73) Assignee: B. G. NEGEV TECHNOLOGIES AND APPLICATIONS LTD., Beer Sheva (IL)

(21) Appl. No.: 13/688,276

(22) Filed: Nov. 29, 2012

(51) Int. Cl. H04L 29/06

(52) U.S. Cl. CPC H04L 29/06551
USPC 726/26

(57) ABSTRACT

A method for protecting user privacy in an online social network, comprising the steps of defining, for a given primary user of an online social network who is authorized to post multimedia information in an account of the social network, a personal profile type that characterizes a level of desired privacy and that is selected from a group of predetermined profile types; defining a personal profile type selected from the group for each of a plurality of secondary users who are interested in accessing posted multimedia information of the primary user while functioning as a friend thereof; and denying a request for friendship initiated by one of the plurality of secondary users when the profile type of the primary user and of the one of the plurality of secondary users are incompatible as defined by predetermined rules, that may be stored in the privacy setting module.

### FIELD OF THE INVENTION

The present invention relates to the field of social networks. More particularly, the invention relates to a method for protecting user privacy in social networks.

### BACKGROUND OF THE INVENTION

In recent years, online social networks have grown rapidly and today offer users endless possibilities for publicly expressing themselves, communicating with friends, and sharing information with people across the world. A recent survey estimated that 65% of adult internet users interface with online social network sites.

Online social networks allow users to communicate with one another for various personal and professional purposes. Those users that have been identified by another user as a person with whom there is a preference to grant access to personal information are considered “friends”. A friend is generally identified as a result of an e-mail correspondence, and is then associated with the subject over the social network. After a friendship has been established, a friend is able to access multimedia information posted in an account of the user that granted the friendship.

Due to the friendly nature of social networks such as Facebook, users tend to disclose many personal details about themselves and about their connections. These details can include date of birth, personal pictures, work place, e-mail address, high school name, relationship status, and even phone numbers. Moreover, Bosmaf et al. [“The socialbot network: when bots socialize for frame and money,” in Proceedings of the 27th Annual Computer Security Applications Conference. ACM, 2011, pp. 93-102] discovered that an average of 80% of studied Facebook users accepted friend requests from people they do not know if they share more than 11 mutual friends.

In many cases, accepting a friend request from strangers may result in exposure of a user's personal information to third parties. In addition, personal user information can be exposed to third party applications running on the social network. Another privacy concern deals with existing privacy settings which, for the majority of users, do not match security expectations. Accordingly, many users accidently or unknowingly publish private information, leaving them more exposed than they thought.

If a user's personal information is disclosed to a third malicious party, the personal information can be used to threaten the well-being of the user both online and in the real world. For example, a malicious user can use the gained personal information and send customized spam messages to the user in an attempt to lure such users onto malicious websites or blackmail them into transferring money to the attacker's account.

In order to cover their tracks, social network attackers can use fake profiles. In fact, the number of fake profiles on Facebook can number tens of millions.

However, social networks tend not to impose privacy limitations on users desiring to be friends so as to maximize the ubiquitous and independence promoting nature of the social network.

It is an object of the present invention to provide a method for improving privacy of a subject user in online social networks without compromising the feeling of ubiquitousness and independence that a friend of that subject user senses when communicating therewith over the social network.

Other objects and advantages of the invention will become apparent as the description proceeds.

### SUMMARY OF THE INVENTION

The present invention is directed to a method for protecting user privacy in an online social network, comprising the steps of defining, for a given primary user of an online social network who is authorized to post multimedia information in an account of the social network, a personal profile type that characterizes a level of desired privacy and that is selected from a group of predetermined profile types; defining a personal profile type selected from the group for each of a plurality of secondary users who are interested in accessing posted multimedia information of the primary user while functioning as a friend thereof; and denying a request for friendship initiated by one of the plurality of secondary users when the profile type of the primary user and of the one of the plurality of secondary users are incompatible as defined by predetermined rules, that may be stored in the privacy setting module.

In one aspect, the method further comprises the step of transmitting a recommendation message (that may be generated by ranking a friendship level for each friend of the given primary user) to a communication device of the given primary user which is indicative that a specified secondary user is not fitting to be a friend thereof.

The recommendation message may be indicative that friendship between the given primary user and the specified secondary user should be terminated or restricted.

The given primary user may restrict friendship with the specified secondary user by depressing a button a user interface in response to receiving the recommendation message.

The method may further comprises the step of initiating a restricting event whereby access of an existing friend to multimedia information of the given primary user posted after the restricting event is restricted when the profile type of the given primary user and of the existing friend are incompatible as defined by the predetermined rules, while the existing friend continues to successfully access multimedia information of the given primary user posted prior to the restricting event.

The restricting event may be initiated by a privacy setting module installed in a communication device of the given primary user.

Each profile type of the group of predetermined profile types may be defined by no more than two parameters.

The friendship level may be ranked by scanning a friend list of the given primary user and generating a credibility score based on a number of friendship strengthening events in which both a given friend and the given primary user participated within a predetermined period of time.

The friendship strengthening events may be selected from the group consisting of:
The amount of mutual friends
The amount of mutual chat messages
The amount of mutual tagged photos
The amount of mutual video clips
The amount of mutual groups
The amount of mutual posts on each other's walls
The number of messages sent to a given friend, relative to the total number sent to all friends
Inputs resulting from machine learning

The credibility score may be weighted whereby one friendship strengthening event type is weighted more than another type.

The friendship level of each friend of the given primary user may be ranked and compiled in a list such that those friends having a lower score are displayed at the top of the list.

The method may further comprise the step of alerting the given primary that an application installed in the account thereof presents a security risk when accessed by a friend.

### BRIEF DESCRIPTION OF THE DRAWINGS

In the drawings:

FIG. 1 is a schematic illustration of a social privacy protector system, according to one embodiment of the present invention;

FIG. 2 is a method for ranking a friendship level;

FIG. 3 is an illustration of an exemplary web page in which is displayed a list of friendship levels;

FIG. 4 is a method for ensuring privacy of a subject in a social network, according to one embodiment of the present invention; and

FIG. 5 is an illustration of an exemplary user interface for a privacy setting module.

### DETAILED DESCRIPTION OF PREFERRED EMBODIMENTS

Due to the ubiquitous nature of prior art online social networks, a friendship may be established between any two users, subject to user approval, regardless of a lack of suitability in terms of age, interests, and social or financial standing. As a result, a newly established friend will be able to access personal information of an unsuspecting user, which when added to the information accessed from other unsuspecting users is able to abet malicious online activity including fraud, money transfers and harassment.

On the other hand, a user may be subject to peer pressure if a friend will become disqualified or otherwise removed from a friend list, indicating to others that the given user is not sociable.

The present invention is related to a method for protecting the privacy of a given user in social networks (hereinafter a “subject”) by providing three different layers of protection. The first layer allows subjects to control their profile privacy settings by online selection of most suitable profile privacy settings. The second layer notifies the subject of the number of applications installed on a personal network profile that may impose a threat to his privacy. The third layer analyzes the subject's friend list to identify which friends of the subject are suspected of maintaining a fake profile and therefore imposing a threat on the privacy of the subject. The method therefore restricts the access of those that are suspected of bearing a fake profile to the subject's personal information without removing them from the subject's friend list.

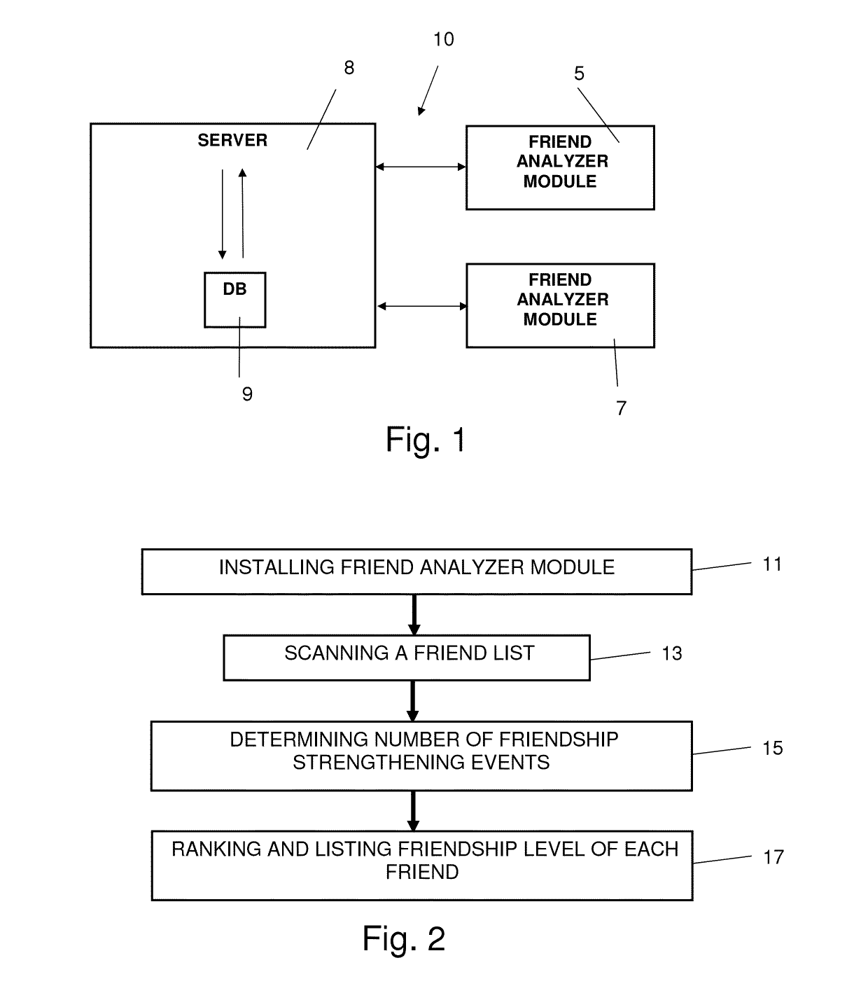

FIG. 1 schematically illustrates a Social Privacy Protector (SPP) system according to one embodiment of the present invention, generally indicated by numeral 10. SPP system 10 may be configured by an application programming interface (API).

SPP system 10 comprises three components that interact synergistically. A friend analyzer module 5 is adapted to rank friends, so as to identify those friends of a given subject who are liable to pose a threat to the subject's privacy and to limit their access. Another module is a privacy setting module 7 for improving the subject's privacy settings according to the user's profile type only by pressing a button. A server 8 which is in data communication with the Internet, or any other data network with which SPP system 10 interfaces, is used to store and cache software results in its database 9 for each subject of the system. Server 8 allows friend analyzer module 5 and privacy setting module 7 to be interfaced. The analyzed software results that are stored in server 8 may be encrypted. Each module can operate independently, even without server 8.

FIG. 2 illustrates operation of the friend analyzer module. After the friend analyzer module is installed in a processor equipped and Internet accessible device of the subject in step 11, the friend analyzer module scans the subject's friend list in step 13 in order to generate a credibility score relating to a friendship level for each friend. Each friend is ranked by heuristically determining a friendship level with the subject. That is, the friendship level is ranked by determining in step 15 a number of friendship strengthening events that have taken place between the friend and the subject during a predetermined period of time, such as, but not limited to, calculating the number of friends that are common to both the subject and the given friend, the number of multimedia information items, e.g. pictures videos, that were tagged to both the subject and the given friend, and the number of messages or phone calls that were transmitted between the subject and the given friend. It will be appreciated that the friendship level can also be determined by providing a weighted score with respect to any of the aforementioned events. The friendship level of each friend associated with the subject is ranked and compiled in a list in step 17. Those friends that have the lowest scores are displayed at the top of the list and have the highest likelihood of having submitted fake profiles to the SPP system.

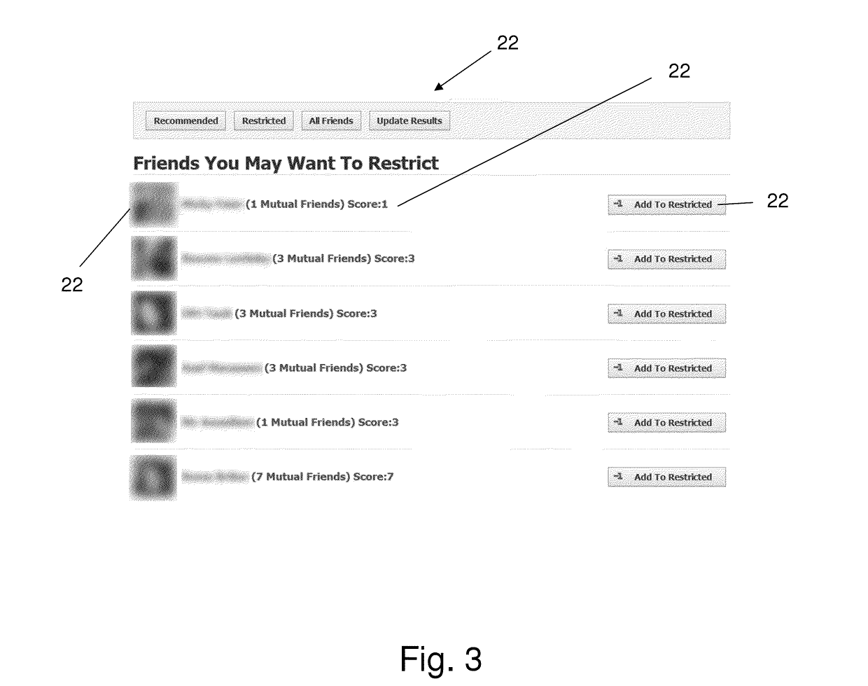

FIG. 3 illustrates an exemplary web page 22 which displays a subject's friend list in terms of ascending friendship level. Each friend 23 is ranked by a score 24, next to which is positioned a subject depressible button 26 for restricting access of the corresponding friend to the subject's personal information. It is also possible to use supervised learning algorithms for ranking, rather than feature ranking.

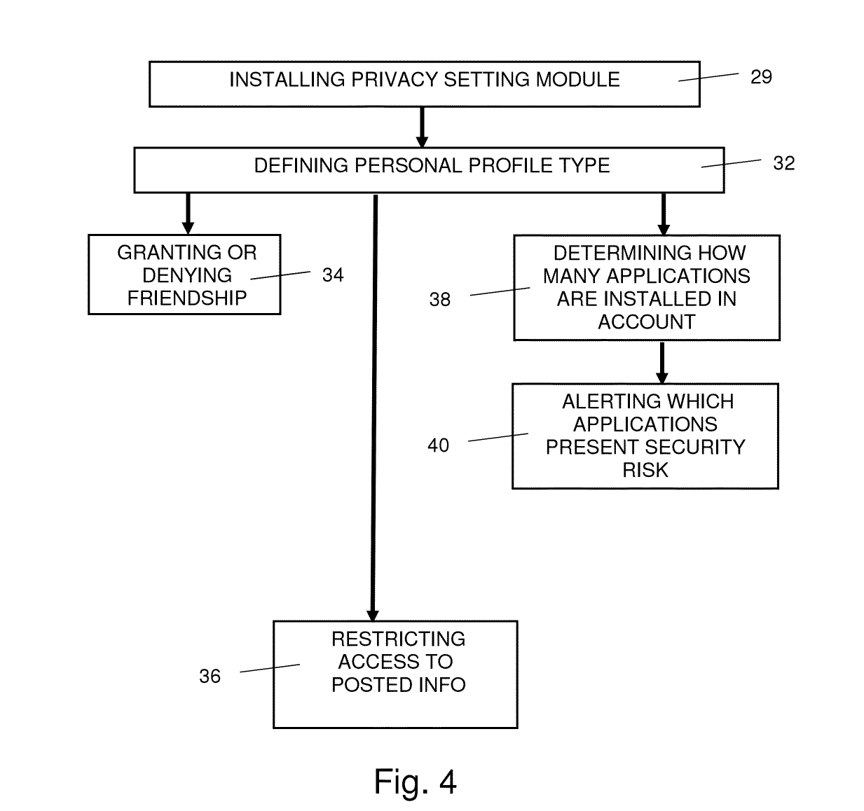

FIG. 4 illustrates operation of the privacy setting module. After the privacy setting module is installed in the subject's device in step 29, the subject defines for himself in step 32, independently or with the assistance of an adult, a personal profile type that characterizes a level of desired privacy. All profile types are predetermined and are supplied by the API, preferably in the form of a selectable icon. Each profile type is well defined by no more than two parameters so as not to be subject to misinterpretation, in contrast to prior art custom privacy settings that provide as many as 170 options, some of which are changed without notice by the service provider, reducing the efficacy of the privacy settings. The privacy settings may be categorized by a celebrity setting for those subjects who prefer that their posted multimedia information be publicly accessible, a recommended setting for limiting access of selected multimedia information to friends while some of the subject's multimedia information such as profile name is publicly accessible, and a youth setting whereby all subject information is accessible only to friends and a new friendship can be granted only to friends of existing friends, or by any other predetermined categories or subcategories. Each predetermined category or subcategory is associated with unique predetermined privacy rules.

A previously defined profile type may be modified, or alternatively, the profile type may be submitted for the first time by a subject whose profile has not yet been stored in the SPP database. A request for friendship from a potential friend is consequently granted or denied in step 34. If granted, personal profile type of the requesting friend is then analyzed.

For example, a request for friendship submitted by a 50 year old potential friend with a 10 year old subject will be denied due to the age disparity. Likewise, a change in the profile type may cause access of an existing friend to the multimedia information posted in an account of the subject to be restricted in step 36. A friend having restricted access will be able to access previously posted multimedia information without arousing suspicion that access to the subject's information has been restricted, yet will not be able to access newly posted information, or even previously posted multimedia information that has not been shared with him in the past.

In addition, the privacy setting module scans the subject account and calculates in step 38, how many applications are installed thereon and alerts the subject in step 40 which of these applications presents a security risk when accessed by a friend.

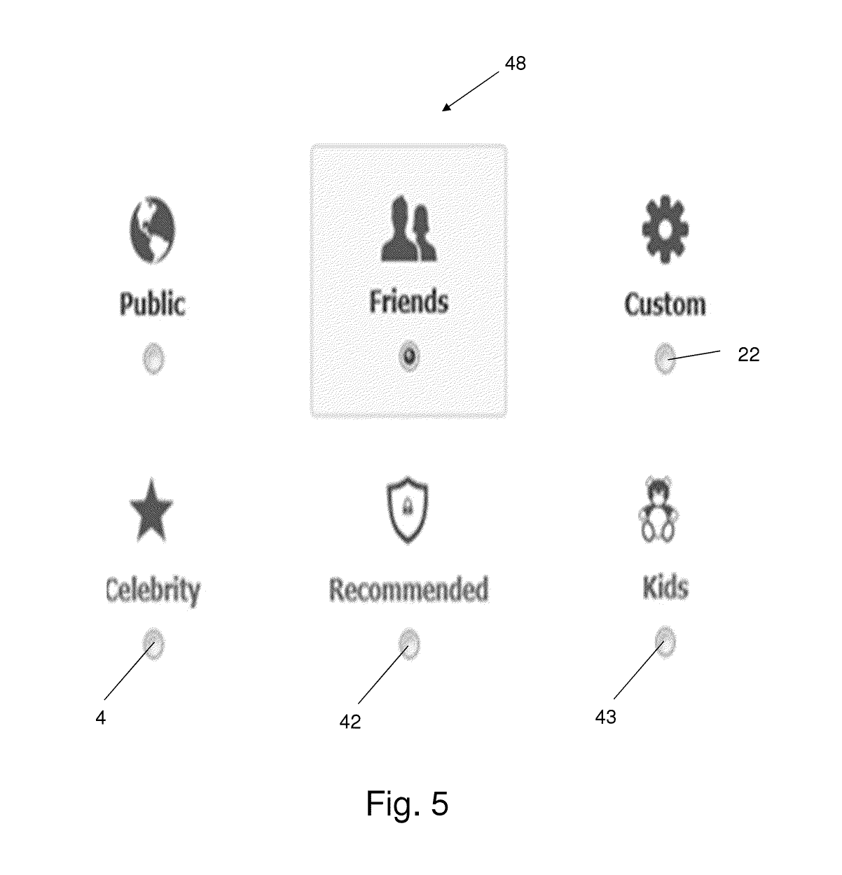

FIG. 5 illustrates a possible user interface 48 for the privacy setting module. Three buttons 41-43 for selecting predetermined categorized privacy settings are shown. Other customized privacy settings may be added for different types of users by selecting the custom button 46 and inputting the desired information. Also other types of user interfaces may also be used.

### EXAMPLE

74 subjects installed the friend analyzer module and 4 subjects installed the privacy setting module. 31 of these subjects imposed a restriction on 392 friends, resulting in a median of 3 restrictions per subject and a deviation of 25:76.

The average number of friends that were common to a subject and the friends he chose to restrict was 12.82 and the average number of common tagged pictures was 0.14.

An initial test of the method proposed by the present invention showed that 3000 user from 20 countries limited more than 10000 friends.

TABLE I
FRIENDS AND RESTRICTED FRIENDS STATISTICS
Feature All Friends Restricted Friends

Common-Friends Average 12.82 32.32
Common-Groups 0.36 0.684
Tagged Pictures 0.14 1.39
Common-Messages 1.31 3.14

While some embodiments of the invention have been described by way of illustration, it will be apparent that the invention can be carried out with many modifications, variations and adaptations, and with the use of numerous equivalents or alternative solutions that are within the scope of persons skilled in the art, without exceeding the scope of the claims.

1. A method for protecting user privacy in an online social network, comprising the steps of:
a) defining, for a given primary user of an online social network who is authorized to post multimedia information in an account of said social network, a personal profile type that characterizes a level of desired privacy and that is selected from a group of predetermined profile types;
b) defining a personal profile type selected from said group for each of a plurality of secondary users who are interested in accessing posted multimedia information of said primary user while functioning as a friend thereof; and
c) denying a request for friendship initiated by one of said plurality of secondary users when the profile type of said primary user and of said one of said plurality of secondary users are incompatible as defined by predetermined rules.

2. The method according to claim 1, further comprising the step of transmitting a recommendation message to a communication device of the given primary user which is indicative that a specified secondary user is not fitting to be a friend thereof.

3. The method according to claim 2, wherein the recommendation message is indicative that friendship between the given primary user and the specified secondary user should be terminated.

4. The method according to claim 2, wherein the recommendation message is indicative that friendship between the given primary user and the specified secondary user should be restricted.

5. The method according to claim 4, wherein the given primary user restricts friendship with the specified secondary user by depressing a button a user interface in response to receiving the recommendation message.

6. The method according to claim 1, further comprising the step of initiating a restricting event whereby access of an existing friend to multimedia information of the given primary user posted after said restricting event is restricted when the profile type of the given primary user and of said existing friend are incompatible as defined by the predetermined rules, while said existing friend continues to successfully access multimedia information of the given primary user posted prior to said restricting event.

7. The method according to claim 6, wherein the restricting event is initiated by a privacy setting module installed in a communication device of the given primary user.

8. The method according to claim 7, wherein the predetermined rules are stored in the privacy setting module.

9. The method according to claim 1, wherein each profile type of the group of predetermined profile types is defined by no more than two parameters.

10. The method according to claim 2, wherein the recommendation message is generated by ranking a friendship level for each friend of the given primary user.

11. The method according to claim 10, wherein the friendship level is ranked by scanning a friend list of the given primary user and generating a credibility score based on a number of friendship strengthening events in which both a given friend and the given primary user participated within a predetermined period of time.

12. The method according to claim 11, wherein the friendship strengthening events are selected from the group consisting of:
The amount of mutual friends
The amount of mutual chat messages
The amount of mutual tagged photos
The amount of mutual video clips
The amount of mutual groups
The amount of mutual posts on each other's walls
The number of messages sent to a given friend, relative to the total number sent to all friends
Inputs resulting from machine learning

13. The method according to claim 12, wherein the credibility score is weighted whereby one friendship strengthening event type is weighted more than another type.

14. The method according to claim 11, wherein the friendship level of each friend of the given primary user is ranked and compiled in a list such that those friends having a lower score are displayed at the top of said list.

15. The method according to claim 1, further comprising the step of alerting the given primary that an application installed in the account thereof presents a security risk when accessed by a friend.
